(19) United States
(12) Patent Application Publication
(10) Pub. No.: US 2006/0262975 A1
(43) Pub. Date: Nov. 23, 2006

(54) Label including identifier having specific color or shape and distribution system using the same

(76) Inventor: Lee Jung Gyu, Gumi-City (KR)

Correspondence Address: CANTOR COLBURN, LLP, 55 GRIFFIN ROAD SOUTH, BLOOMFIELD, CT, 06002, US

(21) Appl. No.: 11/403,254

(22) Filed: Apr. 13, 2006

(30) Foreign Application Priority Data
Apr. 13, 2005 (KR) 10-2005-0030742

(51) Int. Cl. G06K 9/00

(52) U.S. Cl. 382/181

(57) ABSTRACT

A distribution system using labels including identifiers having specific colors or shapes is provided. A label, on which an identifier having a specific color or shape is formed at a specific position, is attached to an item for delivery. The identifier allows the item to be classified by destination according to the specific color, shape, or position. A main storage receives the item including the label supplied from the supplier. The item is shipped from the main storage, an image of the identifier is identified, and the item is delivered to a corresponding destination via an intermediate distribution storage and local centers. The destinations of items can be determined using labels having specific colors or shapes. This eliminates the need for deliverers to read characters written on the labels with the naked eye, thereby reducing work time, and allows correct determination of the destinations, thereby preventing delivery delays or failures.

### BACKGROUND OF THE INVENTION

1. Field of the Invention

The present invention relates to a distribution system, and more particularly to a label including an identifier having a specific color or shape and a distribution system using the label.

2. Description of the Related Art

FIG. 1 illustrates a label that is applied to a conventional distribution system. The conventional distribution system delivers each item after attaching a label 10 as shown in FIG. 1, which identifies its destination, to the item. A number of labels 10 are sequentially printed on label printable material 12. One by one, the labels 10 are separated from the label printable material 12 and are then attached to corresponding items.

Specifically, when delivering each item, the conventional distribution system uses the label 10, on which a barcode is recorded together with characters describing an address of the destination, to identify the destination of the item.

However, the conventional distribution system requires a long working time for deliverers to classify items to be delivered by destination since they inconveniently have to read characters written on labels attached to the items one by one with the naked eye to identify their destinations. Thus, the conventional distribution system requires a large labor force and causes delivery delays or failures due to incorrect reading of the characters describing the destinations.

### SUMMARY OF THE INVENTION

Therefore, the present invention has been made in view of the above problems, and it is an object of the present invention to provide a distribution system that delivers items using labels including identifiers, each having a specific color and shape, so that destinations of the items are quickly and correctly identified.

In accordance with one aspect of the present invention, the above and other objects can be accomplished by the provision of a distribution system using a label including an identifier having a specific color or shape, the distribution system comprising attaching a label, on which an identifier having a specific color or shape is formed at a specific position, to an item to be delivered and supplying the item from a supplier, the identifier allowing the item to be classified by destination according to the specific color, shape, or position of the identifier; receiving, by a main storage, the item including the label attached thereto from the supplier; and shipping the item from the main storage, identifying an image of the identifier, and delivering the item to a corresponding destination via an intermediate distribution storage and each local center.

Preferably, the shape of the identifier represents the shape of a transporter so that the item is delivered to the destination by a transporter corresponding to the shape of the identifier.

In accordance with another aspect of the present invention, there is provided a label to be attached to an item to be delivered, wherein an identifier having a specific color or shape is formed on the label at a specific position thereof, the identifier allowing the item to be classified by destination according to the specific color, shape, or position of the identifier.

Preferably, the shape of the identifier represents the shape of a transporter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a label that is applied to a conventional distribution system;

FIG. 2 illustrates an embodiment of a label including an identifier having a specific color or shape, which is applied to a distribution system according to the present invention;

FIG. 3 illustrates receiving management of a distribution system using labels including identifiers having specific colors and shapes according to the present invention;

FIG. 4 illustrates shipping management of the distribution system using labels including identifiers having specific colors and shapes according to the present invention; and

FIGS. 5-7 illustrate a variety of embodiments of a label including an identifier having a specific color or shape according to the present invention.

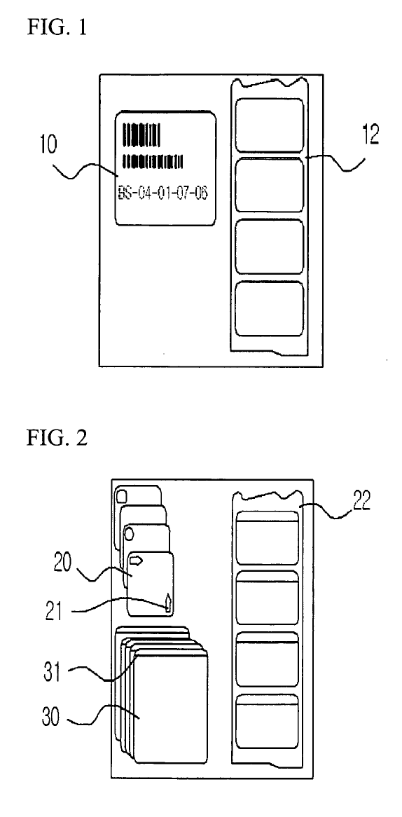

### DESCRIPTION OF THE PREFERRED EMBODIMENTS

Preferred embodiments of the present invention will now be described with reference to the accompanying drawings.

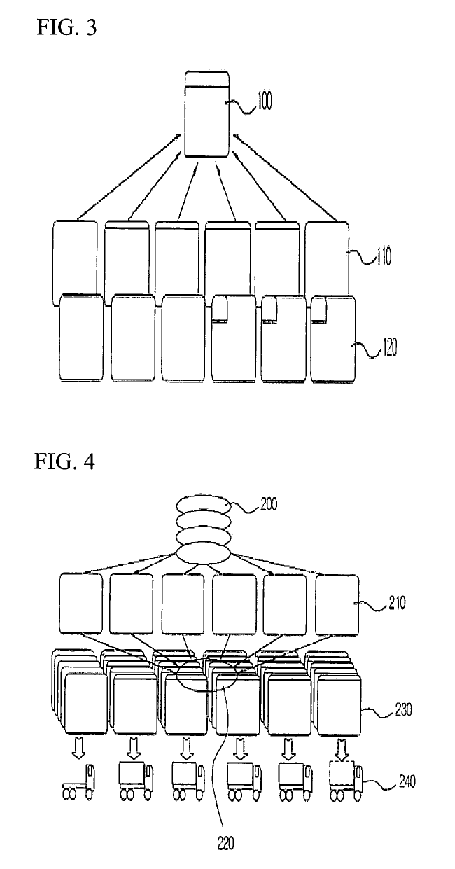

FIG. 2 illustrates an embodiment of a label including an identifier having a specific color or shape, which is applied to a distribution system according to the present invention.

In this embodiment, identifiers 21 and 31, each having a specific color or shape, are formed at specific positions of labels 20 and 30 that will be attached to items to be delivered as shown in FIG. 2. Attaching labels 20 and 30 including such identifiers 21 and 31 to items ensures that the items are classified by destination based on specific colors, shapes, or positions of the identifiers 21 and 31.

Specifically, identifiers 21 or 31, each having a specific color or a specific shape (for example, a quadrilateral, hexagonal, arrow, or strip shape), are formed on labels 20 or 30 to be attached to items at specific positions (for example, at left, right, top or bottom positions) of the labels 20 or 30, whereby the items are classified by delivery destinations, distribution storages (specifically, intermediate distribution warehouses), local centers, or the like.

Preferably, a number of labels 20 are sequentially printed on label printable material 22, and, one by one, the labels 20 are separated from the label printable material 22 and are then attached to corresponding items.

In the above manner, labels including colored strip identifiers, colored line identifiers, and identifiers having various other colored shapes are printed on a barcode label sheet (or any barcode printable material) and the labels are attached to corresponding items. Each identifier indicates a manufacturing factory, a manufacturing line (or process), a product storage, a raw material storage, a distribution center, a storage space (classified into a large, medium, and small storage space), a destination (or ship-to location), a transportation method (classified into freight transportation, rail transportation, home-delivery, air transportation, mail, and registered mail), or the like corresponding to the item. Thus, attaching labels, on which colored strip identifiers, colored line identifiers, and identifiers having other colored shapes are printed, to items ensures that, when classifying the items, anybody can easily identify processing places, manufacturing places (for example, factories, makers, or manufacturing lines), delivery destinations, or the like of the items with the naked eye from a distance. This allows small labor force to quickly and easily classify the items without errors.

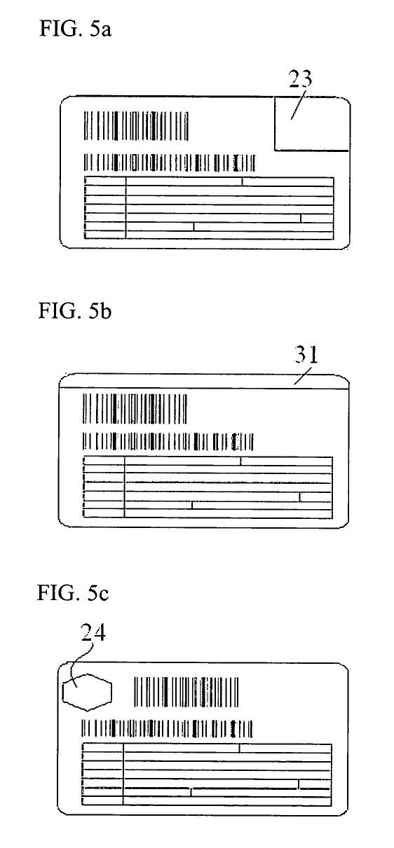

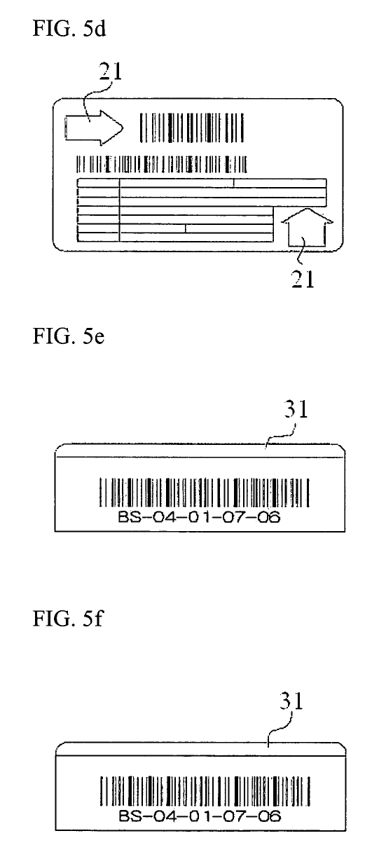

FIG. 3 illustrates receiving management of a distribution system using labels including identifiers having specific colors and shapes according to the present invention, and FIG. 4 illustrates shipping management of the distribution system according to the present invention.

In the distribution system according to the present invention, a label 20, on which an identifier 21 having a specific color or shape is formed at a specific position, is attached to an item to be delivered and the item is then supplied by a supplier 120. Here, the identifier 21 allows the item to be classified by destination according to the specific color, shape, or position of the identifier 21.

Then, a main storage 100 receives the item with the label 20 attached thereto from the supplier 120.

The item is shipped from the main storage 100 via a shipping storage 200, an image of the identifier 21 is identified, and the item is delivered to its destination via an intermediate distribution storage 220 and local centers 210 and 230 according to the identified image of the identifier 21.

The shape of the identifier 21 may represent the shape of a transporter 240 so that the item is delivered to its destination by a transporter 240 corresponding to the shape of the identifier 21.

Although the color and shape of the identifier 21 formed on the label 20 may be identified directly with the naked eye of a worker, the color and shape of the identifier 21 may also be identified by capturing its image with a camera and reading the captured image on a monitor or automatically analyzing the captured image by a computer.

In the distribution system of the present invention, when the main storage 100 receives items (specifically, raw materials, parts, or products) from sub-storages 110 and suppliers 120, the received items can be easily classified by the sub-storages 110 and the suppliers 120 using barcode labels 20 attached to the items, the barcode labels having identifiers having various shapes or colors corresponding respectively to the sub-storages 110 and the suppliers 120.

Using such labels 20 having specific colors or shapes, workers can quickly identify the items with the naked eye or through identification or recognition of an image captured by a camera. This makes it easy to find an urgent item, thereby minimizing labor or time loss in finding the item. With the naked eye, workers can also easily manage items in stock and determine the amount of stock on a storage by storage basis and on a supplier by supplier basis, thereby reducing labor or time loss. The destinations of items received from suppliers can also be easily managed on a supplier by supplier basis, thereby making it easy to manage and store items in each storage and thus minimizing labor force. This also reduces the time required to receive and ship items. In addition, items can be easily received and stored on a supplier by supplier basis and can also be easily classified by manufacturing dates, thereby achieving easy first-in first-out of items. This prevents alteration of items (specifically, parts) stored for a long time.

When items to be shipped are packed at each manufacturing factory, labels having colors specified respectively for local shipping destinations (i.e., local centers 230) of the items are attached to the items so that intermediate distribution storages or centers 220 can classify the items by the specified colors (i.e., by the local centers 230) and then deliver the items to the final delivery destinations (i.e., the local centers 230).

Using such labels 20 having specific colors or shapes, workers can quickly classify the items by their final delivery destinations with the naked eye or through identification or recognition of an image captured by a camera, thereby reducing work time and labor force. Thus, the items can be quickly stored and moved, thereby reducing the time required to distribute the items. Items can be quickly shipped from intermediate storages on a destination by destination basis and transportation vehicles can be easily allocated to the items on a destination by destination basis, and items to be shipped can also be easily specified on a time or hourly basis, thereby reducing the time and labor costs required to ship the items.

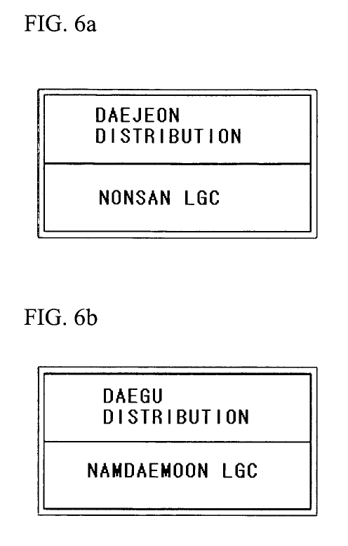

FIGS. 5-7 illustrate a variety of embodiments of a label including an identifier having a specific color or shape according to the present invention.

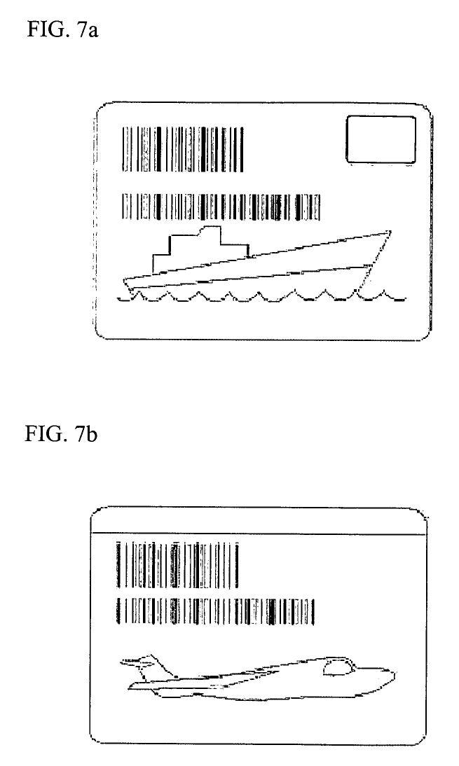

As shown in FIGS. 5 and 6, the present invention may provide various types of labels including identifiers that have specific colors or shapes and are formed at specific positions of the labels and that allow items to be classified by their destinations according to the specific colors, shapes, or positions, wherein the identifiers may be formed alone or together with barcodes or characters on the labels.

In an example of FIG. 5a, a quadrilateral identifier 23 is formed on a label at a corner thereof. In an example of FIG. 5b, a colored strip identifier 31 is formed on a label at an upper side thereof. In an example of FIG. 5c, a hexagonal identifier 24 is formed on a label at a corner thereof. In an example of FIG. 5d, two arrow identifiers 21 are formed on a label at two corners thereof. In examples of FIGS. 5e and 5f, a strip identifier 31 is formed above a barcode on a label. In the examples of FIGS. 5a-5f, colored strip identifiers, colored line identifiers, and identifiers having other colored shapes are printed on labels to be attached to items. Each identifier indicates a product storage, a raw material storage, a distribution center, a storage space (classified into a large, medium, and small storage space), a destination, a transportation method (classified into freight transportation, rail transportation, home-delivery, air transportation, mail, and registered mail), or the like corresponding to the item. Thus, attaching labels, on which colored strip identifiers, colored line identifiers, and identifiers having other colored shapes are printed, to items ensures that, when classifying the items, anybody can easily identify processing places, manufacturing places (for example, factories, makers, or manufacturing lines), delivery destinations, or the like of the items with the naked eye from a distance. This allows small labor force to quickly and easily classify the items without errors.

An example identifier shown in FIG. 6a has a red background color indicating a Daejeon distribution center and an example identifier shown in FIG. 6b has a yellow background color indicating a Daegu distribution center so that anybody can easily identify the distribution center by viewing the background color. When classifying items, workers can easily identify their distribution centers by viewing background colors of identifiers printed on labels attached to the items. Such identifiers can also be applied to delivery of items.

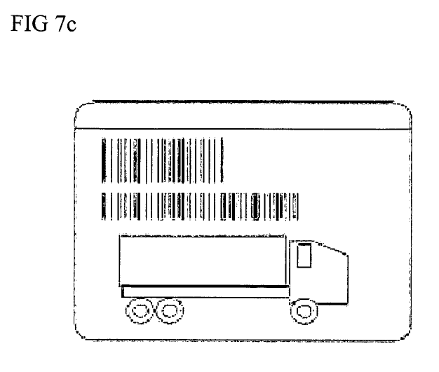

In examples of FIGS. 7a-7c, an identifier having a shape indicating a transporter is printed on a label to be attached to an item that is to be delivered by the transporter.

In the example of FIG. 7a, an identifier having a color or shape indicating a delivery destination, a manufacturing place, or an intermediate distribution center of an item is printed on a label to be attached to the item so that the item is classified by the delivery destination or the like according to the color or shape of the identifier. An identifier having a shape indicating a ship as a transporter of the item is also printed on the label, thereby preventing workers from erroneously classifying items by their transporters.

In the example of FIG. 7b, a strip identifier having a color indicating a delivery destination or the like of an item is printed on a label to be attached to the item so that the item is classified by the delivery destination or the like according to the strip color or shape of the identifier. An identifier having a shape indicating an airplane as a transporter of the item is also printed on the label, thereby preventing workers from erroneously classifying items by their transporters.

In the example of FIG. 7c, a strip identifier having a color indicating a delivery destination or the like of an item is printed on a label to be attached to the item so that the item is classified by the delivery destination or the like according to the strip color or shape of the identifier. An identifier having a shape indicating a vehicle as a transporter of the item is also printed on the label, thereby preventing workers from erroneously classifying items by their transporters.

Although two identifiers are printed on a label in the examples of FIGS. 7a-7c, one identifier having a shape indicating a transporter and having a color indicating a delivery destination or the like may be printed.

That is, an identifier, which has a specific color and shape indicating the destination of an item, is formed on a label to be attached to the item at a specific position of the label so that the item is classified by the destination according to the color, shape, or position of the identifier, wherein the shape of the identifier preferably indicates a transporter of the item.

Thus, the item is delivered to the destination by a transporter determined based on the shape of the identifier, thereby achieving rapid and correct delivery to the destination.

As is apparent from the above description, the present invention provides a label including an identifier having a specific color or shape and a distribution system using the label, wherein the destinations of items can be quickly and correctly determined (or identified) using labels having specific colors or shapes corresponding respectively to the destinations. This eliminates the need for deliverers to read characters written on the labels one by one with the naked eye, thereby reducing work time, and allows correct determination of the destinations, thereby preventing delivery delays or failures. Thus, the present invention is very useful for the distribution industry.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A distribution system using a label including an identifier having a specific color or shape, the distribution system comprising:
attaching a label, on which an identifier having a specific color or shape is formed at a specific position, to an item to be delivered and supplying the item from a supplier, the identifier allowing the item to be classified by destination according to the specific color, shape, or position of the identifier;
receiving, by a main storage, the item including the label attached thereto from the supplier; and
shipping the item from the main storage, identifying an image of the identifier, and delivering the item to a corresponding destination via an intermediate distribution storage and each local center.

2. The distribution system according to claim 1, wherein the shape of the identifier represents the shape of a transporter so that the item is delivered to the destination by a transporter corresponding to the shape of the identifier.

3. A label to be attached to an item to be delivered, wherein an identifier having a specific color or shape is formed on the label at a specific position thereof, the identifier allowing the item to be classified by destination according to the specific color, shape, or position of the identifier.

4. The label according to claim 3, wherein the shape of the identifier represents the shape of a transporter.
